(19) United States
(12) Patent Application Publication
(10) Pub. No.: US 2012/0013511 A1
(43) Pub. Date: Jan. 19, 2012

(54) PORTABLE RADIO

(75) Inventors: Shingo Sumi, Miyagi (JP); Toshihiro Asahina, Kanagawa (JP)

(73) Assignee: PANASONIC CORPORATION, Osaka (JP)

(21) Appl. No.: 13/259,979

(22) PCT Filed: Dec. 3, 2010
(86) PCT No.: PCT/JP2010/007071

§ 371 Date: Sep. 23, 2011

(30) Foreign Application Priority Data
Dec. 4, 2009 (JP) 2009-276559

(51) Int. Cl. H01Q 1/24

(52) U.S. Cl. 343/702

(57) ABSTRACT

An object of the invention is to provide a portable radio apparatus capable of attaining a higher level of antenna performance in each of a plurality of frequency bands, without making the portable radio apparatus larger. A ground wire, which is set with an electrical length resonating at a second frequency band, which is different from that of an antenna element 14, of two or more carrier frequency bands in which a wireless circuit on a circuit board 11 operates, is arranged between a ground pattern of the circuit board 11 and the antenna element 14 and the operating states of the ground wire 15 are switched by a line switching switch 16, depending on the using frequency band. Thereby, it is possible to attain the higher level of antenna performance in each of the first frequency band with which the antenna element 14 resonates and the second frequency band with which the ground wire 15 resonates. In addition, the ground wire 15 is arranged in a space that is required to secure the characteristics of the antenna element 14. Accordingly, it is not necessary to secure a new mount space for the ground wire 15, so that the portable radio apparatus 1 is not enlarged.

### TECHNICAL FIELD

The present invention relates to a portable radio apparatus such as cellular phone and the like, and more particularly, to a portable radio apparatus being operable in a plurality of frequency bands.

### BACKGROUND ART

Conventionally, Patent Documents 1 to 3 disclose an antenna device being operable in a plurality of frequency bands or a portable radio apparatus having the antenna device. According to the antenna device and the wireless communication apparatus disclosed in Patent Document 1, a passive element is arranged at a position adjacent to a feed side or open side of an antenna element (feed element) and is electromagnetically coupled to the antenna element, so that resonance can be made at two frequency bands by the antenna element and the passive element. According to a microstrip antenna disclosed in Patent Document 2, the microstrip antenna (plate-shaped inverted-F antenna) and a ground wire are arranged in parallel with a ground conductor (substrate), so that resonance can be made at two frequency bands by the microstrip antenna and the ground wire. According to a folder-type portable radio apparatus disclosed in Patent Document 3, a matching circuit of an antenna element and a wireless unit is switched depending on the frequency bands to be used to take an optimal impedance matching in the respective frequency bands, so that a VSWR (Voltage Standing Wave Ratio) of the antenna element and the wireless unit is suppressed in the respective frequency bands and a higher level of antenna performance is thus achieved.

### RELATED ART DOCUMENTS

Patent Documents

| | |
|---|---|
| Patent Document 1 | JP-A-2008-160314 |
| Patent Document 2 | JP-A-9-260934 |
| Patent Document 3 | JP-A-2009-182851 |

### SUMMARY OF THE INVENTION

Problem to be Solved by the Invention

The related arts disclosed in Patent Documents 1 to 3 provide the general method with which the antenna element supports the plurality of frequency bands. However, the following problems are caused.

In Patent Documents 1 and 2, it is possible to attain a high level of an antenna performance in the respective frequency bands. However, a space for arranging the ground wire (the passive element) is required, which makes the portable radio apparatus larger.

In Patent Document 3, it is possible to suppress the mismatching between the antenna element and the wireless unit in the respective frequency bands. However, since an electrical volume of the antenna element itself is not switched, the radiation resistance is not maximized in all the frequency bands, so that the effect is lowered, compared to a configuration in which a radiation element such as ground wire is used.

The invention has been made to solve the above problems. An object of the invention is to provide a portable radio apparatus capable of attaining a higher level of antenna performance in each of a plurality of frequency bands, without making the portable radio apparatus larger.

Means for Solving the Problem

According to the present invention, there is provided a portable radio apparatus, comprising: a circuit board having a ground pattern; a first feed part connected to a wireless circuit on the circuit board; a first antenna element connected to the first feed part; a passive element arranged between the ground pattern and the first antenna element; and a line switching section that connects the ground pattern and one end of the passive element, wherein the wireless circuit operates in two or more carrier frequency bands; wherein the first antenna element is set with an electrical length resonating in at least one frequency band of the carrier frequency bands; wherein the passive element is set with an electrical length resonating in a frequency band, which is different from the frequency band of the first antenna element, of the carrier frequency bands; and wherein the line switching section electrically separates the ground pattern from the passive element in the frequency band with which the first antenna element resonates, and electrically connects the ground pattern to the passive element in the frequency band with which the passive element resonates.

According to the above configuration, the passive element (ground wire), which is set with an electrical length resonating at a frequency band (referred to as “second frequency band”), which is different from that of the first antenna element, of the two or more carrier frequency bands with which the wireless circuit operates, is arranged between the ground pattern of the circuit board and the first antenna element and the operating states of the passive element are switched depending on the using frequency bands. Accordingly, it is possible to attain the higher level of antenna performance in each of the frequency band (referred to as “first frequency band”) with which the first antenna element resonates and the second frequency band with which the passive element resonates. In addition, the passive element is arranged in a space that is required to secure the characteristics of the first antenna element, i.e., between the first antenna element and the ground pattern of the wireless circuit. Accordingly, it is not necessary to secure a new mount space for the passive element, so that the portable radio apparatus is not enlarged.

In the above configuration, the wireless radio includes a metal conductor connected to the ground pattern and provided to a ground pattern side.

According to the above configuration, even when the ground pattern of the circuit board is not located at a position opposed to the antenna element, the metal conductor is located at a position opposed to the antenna element, so that the passive element is positioned between the antenna element and the ground pattern. Hence, it is possible to attain the higher level of antenna performance in each of the first frequency band with which the first antenna element resonates and the second frequency band with which the passive element resonates.

In the above configuration, the passive element is configured as a circuit pattern formed on the circuit board.

According to the above configuration, the passive element is formed as a part of the circuit pattern of the circuit board, so that it is possible to reduce the cost, compared to a configuration in which the passive element is independently prepared.

According to the present invention, there is provided a portable radio apparatus including: a circuit board having a ground pattern; a first feed part connected to a wireless circuit on the circuit board; a first antenna element connected to the first feed part; a passive element that arranged between the ground pattern and the first antenna element; a line switching section that connects the ground pattern and one end of the passive element; a first housing that includes the circuit board, the first feed part, the first antenna element, the passive element and the line switching section; and a second housing slidably connected to the first housing, wherein the wireless circuit operates in two or more carrier frequency bands; wherein the first antenna element is set with an electrical length resonating in at least one frequency band of the carrier frequency bands; wherein the passive element is set with an electrical length resonating in a frequency band, which is different from the frequency band of the first antenna element, of the carrier frequency bands; and wherein the line switching section electrically separates the ground pattern from the passive element in the frequency band with which the first antenna element resonates, and electrically connects the ground pattern and the passive element in the frequency band with which the passive element resonates.

According to the above configuration, even with the portable radio apparatus having the two housings, it is possible to attain the higher level of antenna performance in each of the first frequency band with which the first antenna element resonates and the second frequency band with which the passive element resonates, by switching the operating states of the passive element (ground wire) depending on the using frequency bands. In addition, since the passive element is arranged in the space that is required to secure the characteristics of the first antenna element, i.e., between the first antenna element and the ground pattern, it is not necessary to secure a new mount space for the passive element, so that the portable radio apparatus is not enlarged.

In the above configuration, the portable radio apparatus includes a metal conductor connected to the ground pattern and provided in the second housing.

According to the above configuration, even when the ground pattern of the circuit board is not located at a position opposed to the antenna element, the metal conductor is located at a position opposed to the antenna element, so that the passive element is positioned between the antenna element and the ground pattern. Hence, it is possible to attain the higher level of antenna performance in each of the first frequency band with which the first antenna element resonates and the second frequency band with which the passive element resonates.

In the above configuration, the passive element is configured as a circuit pattern formed on the circuit board.

According to the above configuration, the passive element is formed as a part of the circuit pattern of the circuit board, so that it is possible to reduce the cost, compared to a configuration in which the passive element is independently prepared.

In the above configuration, the portable radio apparatus includes a reactance element provided between the line switching section and the ground pattern.

According to the above configuration, the reactance element is provided, so that it is possible to adjust a length of the passive element (mainly, to shorten the length of the passive element). In this case, the electrical length having electrically added the passive element, the line switching section and the reactance element resonates in the second frequency band.

In the above configuration, the portable radio apparatus includes a reactance element provided between the passive element and the line switching section.

According to the above configuration, even when the reactance element is provided between the line switching section and the ground pattern, it may be difficult to make a configuration that substantially open in a lumped-constant manner is assumed by the reactance element and the line switching section, depending on the length of the passive element. In this case, a new reactance element is provided between the passive element and the line switching section, so that it is easy to make a configuration that substantially open in a lumped-constant manner is assumed. As a result, it is easy to make a design.

In the above configuration, the portable radio apparatus includes a second feed part connected to the wireless circuit on the circuit board; and a second antenna element connected to the second feed part, wherein the second antenna element is set with an electrical length resonating in a frequency band (referred to as “third frequency band”), which is different from the frequency bands of the first antenna element and the passive element, of the carrier frequency bands.

According to the above configuration, the magnitude relation among the third frequency band and the first and second frequency bands is made so that the third frequency band>the second frequency band>the first frequency band or the first frequency band>the second frequency band>the third frequency band is satisfied. Therefore, it is possible to attain the higher level of antenna performance in the respective frequency bands.

### ADVANTAGES OF THE INVENTION

According to the invention, it is possible to provide a portable radio apparatus capable of supporting a plurality of frequency bands and attaining a higher level of antenna performance in each of a plurality of frequency bands, without making the portable radio apparatus larger.

### BRIEF DESCRIPTION OF THE DRAWINGS

FIG. 1 is a view of showing a schematic internal configuration of a portable radio apparatus according to a first embodiment of the invention.

FIG. 2 is a view of showing operating states of a line switching switch of the portable radio apparatus of FIG. 1, in which FIG. 2(a) shows an operating state of the line switching switch when a ground wire operates, and FIG. 2(b) shows an operating state of the line switching switch when a ground wire does not operate.

FIG. 3 shows antenna efficiency of the portable radio apparatus of FIG. 1.

FIG. 4 is a view of showing a schematic internal configuration of a portable radio apparatus according to a second embodiment of the invention, in which FIG. 4(a) is a front view of showing the schematic internal configuration of the portable radio apparatus and FIG. 4(b) is a side view of showing the schematic internal configuration of the portable radio apparatus.

FIG. 5 is a view of showing a schematic internal configuration of a portable radio apparatus according to a third embodiment of the invention, in which FIG. 5(a) is a front view of showing the schematic internal configuration of the portable radio apparatus and FIG. 5(b) is a side view of showing the schematic internal configuration of the portable radio apparatus.

FIG. 6 is a view of showing a schematic internal configuration of a portable radio apparatus according to a fourth embodiment of the invention, in which FIG. 6(a) is a front view of showing the schematic internal configuration of the portable radio apparatus and FIG. 6(b) is a side view of showing the schematic internal configuration of the portable radio apparatus.

FIG. 7 is a view of showing a schematic internal configuration of a portable radio apparatus according to a fifth embodiment of the invention.

FIG. 8 is a view of showing a schematic internal configuration of a portable radio apparatus according to a sixth embodiment of the invention.

FIG. 9 shows antenna efficiency of the portable radio apparatus of FIG. 8.

FIG. 10 is a view of showing a schematic internal configuration of a modified embodiment of the portable radio apparatus shown in FIG. 8.

### MODES FOR CARRYING OUT THE INVENTION

Hereinafter, embodiments of the invention will be specifically described with reference to the drawings.

(First embodiment)

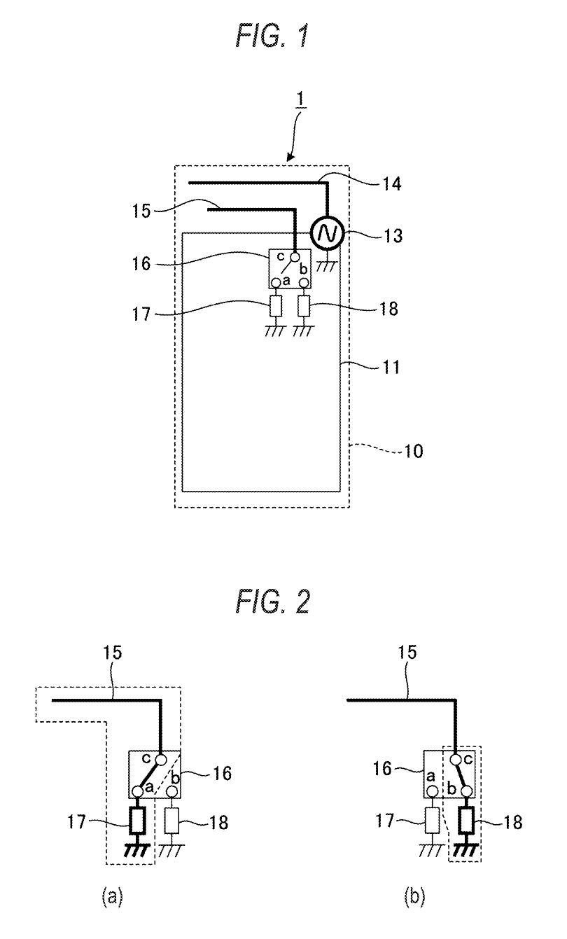

FIG. 1 is a view of showing a schematic internal configuration of a portable radio apparatus according to a first embodiment of the invention. In FIG. 1, a portable radio apparatus 1 according to this embodiment has an integrated housing 10 that is referred to as a straight type, a circuit board 11 having a ground pattern, a feed part (first feed part) 13 that is connected to a wireless circuit (not shown) on the circuit board 11, an antenna element (first antenna element) 14 that is connected to the feed part 13, a ground wire (passive element) 15 that is arranged between the ground pattern (not shown) of the circuit board 11 and the antenna element 14, a line switching switch 16 that has one moveable contact point c and two fixed contact points a, b and switches operating states of the ground wire 15, and a first reactance element 17 and a second reactance element 17 that are provided between each of the two fixed contact points a, b of the line switching switch 16 and the ground pattern of the circuit board 11.

The wireless circuit on the circuit board 11 operates in two carrier frequency bands (first frequency band and second frequency band). The antenna element 14 is set with an electrical length that resonates in the first frequency band of the two carrier frequency bands handled by the wireless circuit on the circuit board 11. The ground wire 15 is set with an electrical length (about λ/4), which resonates in the second frequency band, which is different from that of the first frequency band, of the two carrier frequency bands handled by the wireless circuit on the circuit board 11, together with the line switching switch 16 and the reactance element 17.

The ground wire 15 is arranged in a space that is required to secure characteristics of the antenna element 14 (i.e., the space is arranged between the ground pattern of the circuit board 11 and the antenna element 14). The ground wire 15 is arranged in the space, so that it is not necessary to secure a new mount space for the ground wire 15. Hence, the portable radio apparatus 1 is not enlarged.

The line switching switch 16 is arranged adjacent to the feed part 13, separates the ground wire 15 from the ground pattern of the circuit board 11 in the first frequency band with which the antenna element 14 resonates and connects the ground wire 15 to the ground pattern of the circuit board 11 in the second frequency band with which the ground wire 15 resonates. FIGS. 2(a) and 2(b) show the operating states of the line switching switch 16 when the ground wire 15 operates and does not operate. As shown in FIG. 2(a), when the ground wire 15 operates, the moveable contact point c of the line switching switch 16 is switched to the fixed contact point a. In addition, as shown in FIG. 2(b), when the ground wire 15 does not operate, the moveable contact point c of the line switching switch 16 is switched to the fixed contact point b.

A length of the ground wire 15 and a value of the reactance element 17 are predetermined so that the ground wire 15, the line switching switch 16 and the reactance element 17 become the electrical length resonating in the second frequency band when the ground wire 15 operates. In addition, when the ground wire 15 does not operate, a value of the reactance element 18 is determined so that it becomes a phase and impedance close to an open in a lumped-constant manner at the first frequency band.

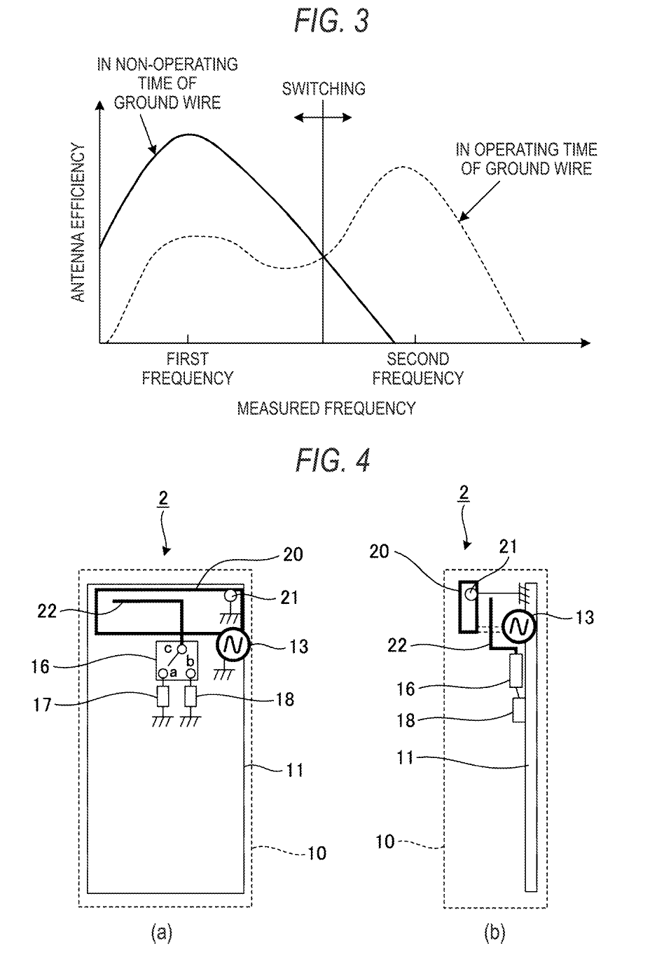

FIG. 3 shows antenna efficiency of the portable radio apparatus 1 of this embodiment. A horizontal axis indicates a measured frequency and a vertical axis indicates antenna efficiency. In the first frequency band in which the ground wire 15 does not operate, the ground wire 15 is electrically floated. Accordingly, the antenna element 14 can attain the higher level of antenna performance, compared to the technologies of simply adding the ground wire 15 (for example, the technologies disclosed in Patent Documents 1 and 2), without being influenced by the ground wire 15. In the meantime, in the second frequency band in which the ground wire 15 operates, the antenna performance is lowered a little, compared to the first frequency band. However, it is possible to attain the higher level of antenna performance, compared to the technology of performing the matching switching (for example, the technology disclosed in Patent Document 3), by optimally adjusting the resonance frequency of the ground wire 15. In general, it is possible to realize the miniaturization and the higher performance, compared to the related arts.

Like this, according to the portable radio apparatus 1 of this embodiment, the ground wire 16, which is set with the electrical length (electrical length including the line switching switch 16 and the reactance element 17) resonating in the second frequency band, which is different from that of the antenna element 14, of the two carrier frequency bands in which the wireless circuit on the circuit board 11 operates, is arranged between the ground pattern of the circuit board 11 and the antenna element 14, and the operating states of the ground wire 15 are switched by the line switching switch 16, depending on the using frequency bands. Therefore, it is possible to attain the higher level of antenna performance in each of the first frequency band with which the antenna element 14 resonates and the second frequency band with which the ground wire 15 resonates. In addition, the ground wire 15 is arranged in the space that is required to secure the characteristics of the antenna element 14, i.e., between the antenna element 14 and the ground pattern of the circuit board 11. Accordingly, it is not necessary to secure a new mount space for the ground wire 15, so that the portable radio apparatus 1 is not enlarged.

(Second Embodiment)

FIG. 4 is a view of showing a schematic internal configuration of a portable radio apparatus according to a second embodiment of the invention, in which FIG. 4(a) is a front view of showing the schematic internal configuration of the portable radio apparatus and FIG. 4(b) is a side view of showing the schematic internal configuration of the portable radio apparatus. In FIG. 4, the common parts to those in FIG. 1 are indicated with the same reference numerals. Like the portable radio apparatus 1 of the first embodiment, a portable radio apparatus 2 of this embodiment has the integrated housing 10 that is referred to as a straight type.

The portable radio apparatus 2 of this embodiment has a plate-shaped inverted-F antenna 20 that is an antenna element and is arranged to face the ground pattern of the circuit board 11. A part of the antenna is connected to the feed part 13 and the other part thereof is connected to the ground pattern of the circuit board 11 through a short point 21. The line switching switch 16 is arranged adjacent to the feed part 13. The ground wire (passive element) 22 is arranged between the plate-shaped inverted-F antenna 20 and the ground pattern of the circuit board 11. The electrical length of the ground wire 22 is about λ/4, compared to the second frequency. In FIG. 4(a), although the ground wire 22 is visibly shown, the ground wire is not actually seen because it is located at a lower side of the plate-shaped inverted-F antenna 20.

In the portable radio apparatus 1 of the first embodiment, the antenna element 14 and the ground wire 15 are arranged in the same direction as a longitudinal direction of the housing 10. However, in the portable radio apparatus 2 of this embodiment, the plate-shaped inverted-F antenna 20 and the ground wire 22 are arranged in the same direction as a thickness direction of the housing 10. Even when the arrangement direction of the antenna and the ground wire is changed, the same effects are realized. Also in the portable radio apparatus 2 of this embodiment, it is possible to attain the higher level of antenna performance in each of the first frequency band in which the plate-shaped inverted-F antenna 20 resonates and the second frequency band with which the ground wire 22 resonates. In addition, the ground wire 22 is arranged in the space that is required to secure the characteristics of the plate-shaped inverted-F antenna 20, i.e., between the plate-shaped inverted-F antenna 20 and the ground pattern of the circuit board 11. Accordingly, it is not necessary to secure a new mount space for the ground wire 22, so that the portable radio apparatus 2 is not enlarged.

(Third Embodiment)

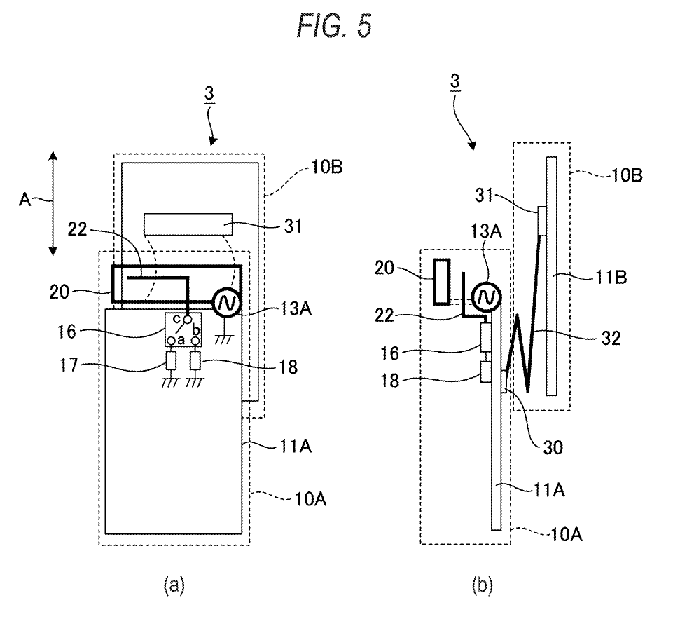

FIG. 5 is a view of showing a schematic internal configuration of a portable radio apparatus according to a third embodiment of the invention, in which FIG. 5(a) is a front view of showing the schematic internal configuration of the portable radio apparatus and FIG. 5(b) is a side view of showing the schematic internal configuration of the portable radio apparatus. In FIG. 5, the common parts to those in FIG. 1 and FIGS. 4(a) and 4(b) are indicated with the same reference numerals.

A portable radio apparatus 3 of this embodiment has two housings of a lower housing 10A and an upper housing 10B, which is referred to as a slide type. By sliding the upper housing 10B in a longitudinal direction of the housing (direction indicated with an arrow A) relatively to the lower housing 10A, the opening and shutting is made. The portable radio apparatus 3 has, in the lower housing 10A, a circuit board 11A having a ground pattern, a feed part 13A that is connected to a wireless circuit (not shown) on the circuit board 11A, a plate-shaped inverted-F antenna 20 that is connected to the feed part 13A, a ground wire (passive element) 22 that is arranged just below the plate-shaped inverted-F antenna 20, a line switching switch 16 that has one moveable contact point c and two fixed contact points a, b and switches operating states of the ground wire 22, a first reactance element 17 and a second reactance element 17 that are provided between each of the two fixed contact points a, b of the line switching switch 16 and the ground pattern of the circuit board 11A, and a connector 30 for electrical connection to the upper housing 10B. The line switching switch 16 is arranged adjacent to the feed part 13A.

In addition, the portable radio apparatus 3 has, in the upper housing 10B, a circuit board 11B having a ground pattern and a connector 31 for electrical connection to the lower housing 10A. Although not shown, a displayer such as LCD (Liquid Crystal Display) is provided to the upper housing 10A. The lower housing 10A and the upper housing 10B are electrically connected by a flexible cable 32. In FIG. 5(a), although the ground wire 22 is visibly shown, the ground wire is not actually seen because it is located at a lower side of the plate-shaped inverted-F antenna 20.

In the portable radio apparatus 3 of this embodiment, since an upper end (an edge of a side at which the line switching switch 16 is arranged) of the circuit board 11A of the lower housing 10A does not reach the plate-shaped inverted-F antenna 20 (i.e., the upper end finishes just before the plate-shaped inverted-F antenna 20), the ground wire 22 is arranged between the plate-shaped inverted-F antenna 20 and the ground pattern of the circuit board 11B in the upper housing 10B, rather than between the plate-shaped inverted-F antenna 20 and the ground pattern of the circuit board 11A. The space just below the plate-shaped inverted-F antenna 20 is a space that is required to secure the characteristics of the plate-shaped inverted-F antenna 20. Accordingly, the ground wire 22 is arranged in the corresponding space.

Even when the ground pattern of the circuit board 11B in the upper housing 10B is used, instead of the ground pattern of the circuit board 11A in the lower housing 10A, the same effects as the first and second embodiments can be realized. In other words, also in the portable radio apparatus 3 of this embodiment, it is possible to attain the higher level of antenna performance in each of the first frequency band with which the plate-shaped inverted-F antenna 20 resonates and the second frequency band with which the ground wire 22 resonates. In addition, the ground wire 20 is arranged in the space that is required to secure the characteristics of the plate-shaped inverted-F antenna 20, i.e., in the space just below the plate-shaped inverted-F antenna 20. Accordingly, it is not necessary to secure a new mount space for the ground wire 22, so that the portable radio apparatus 3 is not enlarged.

(Fourth Embodiment)

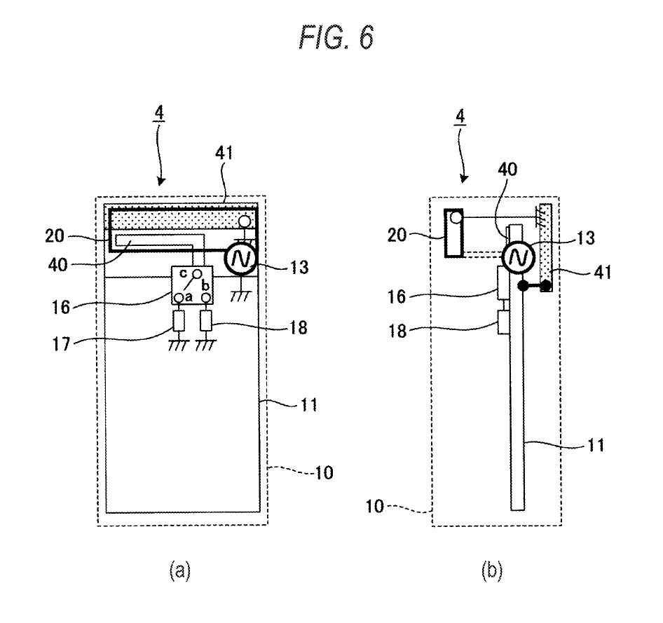

FIG. 6 is a view of showing a schematic internal configuration of a portable radio apparatus according to a fourth embodiment of the invention, in which FIG. 6(a) is a front view of showing the schematic internal configuration of the portable radio apparatus and FIG. 6(b) is a side view of showing the schematic internal configuration of the portable radio apparatus. In FIG. 6, the common parts to those in FIG. 1 and FIGS. 4(a) and 4(b) are indicated with the same reference numerals.

Like the portable radio apparatus 2 of the second embodiment, a portable radio apparatus 4 of this embodiment has the integrated housing 10 that is referred to as a straight type. The portable radio apparatus 4 is different from the portable radio apparatus 2 of the second embodiment, in that a ground wire 40 is configured as a pattern on the circuit board 11 and a metal conductor 41 (hereinafter, referred to as “PIFA back plate”) electrically connected to the ground pattern of the circuit board 11 is provided. The line switching switch 16 is arranged near the feed part 13. In FIG. 6(a), although both the ground wire 40 and the PIFA back plate 41 are visibly shown, the ground wire and the PIFA back plate are not actually seen because they are located at a lower side of the plate-shaped inverted-F antenna 20.

The electrical length of the ground wire 40 is about λ/4, compared to the second frequency. By configuring the ground wire 40 as a pattern on the circuit board 11, it is possible to reduce the cost, compared to a configuration in which the ground wire 40 is independently prepared. The PIFA back plate 41 is arranged in parallel with the circuit board 11 with being spaced from the circuit board 11 at the backside of the circuit board 11 and the upper end of the circuit board 11. Since the PIFA back plate 41 replaces the ground pattern of the circuit board 11, the ground wire 40 is arranged between the PIFA back plate 41 and the plate-shaped inverted-F antenna 20. A part of the plate-shaped inverted-F antenna 20 is connected to the feed part 13 and the other part thereof is connected to the PIFA back plate 41.

Even when the ground wire 40 is configured as the pattern on the circuit board 11 and the PIFA back plate 41 is used instead of the ground pattern of the circuit board 11, the same effects as the first to third embodiments can be realized. In other words, also in the portable radio apparatus 4 of this embodiment, it is possible to attain the higher level of antenna performance in each of the first frequency band with which the plate-shaped inverted-F antenna 20 resonates and the second frequency band with which the ground wire 40 resonates. In addition, the ground wire 40 is arranged in the space that is required to secure the characteristics of the plate-shaped inverted-F antenna 20, i.e., in the space just below the plate-shaped inverted-F antenna 20. Accordingly, it is not necessary to secure a new mount space for the ground wire 40, so that the portable radio apparatus 4 is not enlarged.

(Fifth Embodiment)

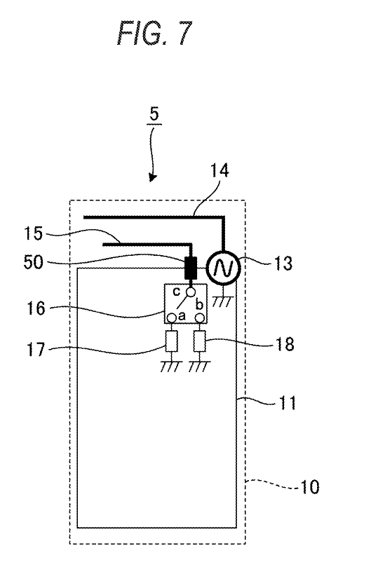

FIG. 7 is a view of showing a schematic internal configuration of a portable radio apparatus according to a fifth embodiment of the invention. In FIG. 7, the common parts to those in FIG. 1 are indicated with the same reference numerals.

Like the portable radio apparatus 1 of the first embodiment, a portable radio apparatus 5 of this embodiment has the integrated housing 10 that is referred to as a straight type. The portable radio apparatus 5 is different from the portable radio apparatus 1 of the first embodiment, in that a reactance element (third reactance element) 50 is inserted between the ground wire 15 and the line switching switch 16. Depending on the length of the ground wire 15, it may be difficult to take a configuration that seems to be substantially open by the line switching switch 16 and the reactance element 18. However, the design is easily made by further arranging the reactance element 50 before the line switching switch 16, in addition to the reactance element 18 behind the line switching switch 16. In the meantime, the effects obtained by the insertion of the third reactance element 50 can be also realized by the above and below embodiments (except for the first embodiment).

(Sixth Embodiment)

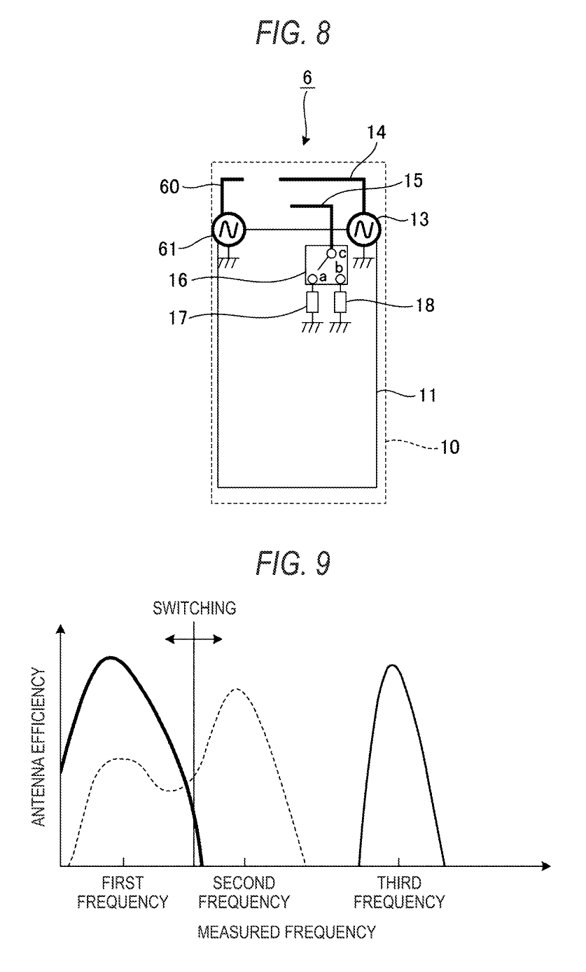

FIG. 8 is a view of showing a schematic internal configuration of a portable radio apparatus according to a sixth embodiment of the invention. In FIG. 7, the common parts to those in FIG. 1 are indicated with the same reference numerals.

A portable radio apparatus 6 of this embodiment has a second antenna element 60 that is set with an electrical length resonating in a frequency band (hereinafter, referred to as “third frequency band”) different from the frequency bands of the antenna element 14 and the ground wire 15, in addition to the antenna element 14 and the ground wire 15. Here, in order to easily distinguish the antenna element 14 and the second antenna element 60, the antenna element 14 is referred to as the first antenna element 14 in the below.

The second antenna element 60 is arranged to be close to the first antenna element 14 at a corner part opposite to one corner part of the upper end of the circuit board 11, at which the first antenna element 14 is arranged. In addition, the second antenna element 60 is connected to a feed part (second feed part) 61 connected to a wireless circuit (not shown) on the circuit board 11 and a ground pattern of the second antenna element 60 is common to the first antenna element 14. FIG. 9 shows antenna efficiency of the portable radio apparatus 6 of this embodiment, in which a horizontal axis indicates a measured frequency and a vertical axis indicates antenna efficiency. Since the first antenna element 14 and the ground wire 15 have been described with reference to FIG. 3, the descriptions thereof are omitted. The third frequency band that is used in the second antenna element 60 is set to be higher than the second frequency band when the ground wire operates. The reason is as follows.

In other words, the first antenna element 14 uses the common ground pattern to the second antenna element 60. Accordingly, when the ground wire does not operate, the first antenna element 14 and the second antenna element 60 are electromagnetically coupled, so that it is not possible to attain the higher level of antenna performance at the frequency close to the third frequency. In addition, when the ground operates, a part of the ground current of the first antenna element 14 flows to the ground wire 15. Accordingly, the electromagnetic coupling of the first antenna element 14 and the second antenna element 60 is weakened, so that it is easy to attain the antenna characteristics even at the frequency close to the third frequency. Therefore, the second frequency may be close to the third frequency but the first frequency is necessarily lower than the third frequency. Since the third frequency is originally set to be higher than the second frequency, the magnitude relation of the respective frequencies is the first frequency <the second frequency<the third frequency. By setting the frequency relation as such, it is possible to attain the higher level of antenna performance in each of the first to third frequency bands.

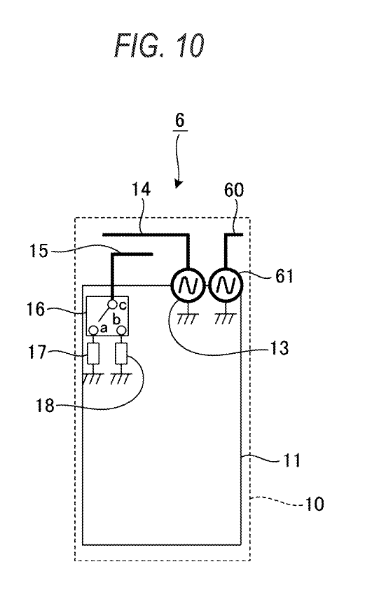

In this embodiment, the second antenna element 60 is arranged at the corner part opposite to the one corner part of the upper end of the circuit board 11, at which the first antenna element 14 is arranged. However, as shown in FIG. 10, the first antenna element 14 and the second antenna element 60 may be arranged adjacent to one corner part of the upper end of the circuit board 11.

In this embodiment, the magnitude relation of the respective frequencies is the first frequency<the second frequency<the third frequency. However, since the same effects can be realized inasmuch as the second frequency is between the first frequency and the third frequency when the ground wire operates, a magnitude relation of the third frequency<the second frequency<the first frequency may be possible.

Although the invention has been specifically described with reference to the specific embodiments, it is apparent to one skilled in the art that the embodiments can be changed or modified without departing from the spirit and the scope of the invention.

The present application claims priority from Japanese Patent Application No. 2009-276559 filed on Dec. 4, 2009, the contents of which are incorporated herein by reference.

### INDUSTRIAL APPLICABILITY

The invention realizes the effects of attaining the higher level of antenna performance in the respective frequency bands without making the portable radio apparatus larger and can be applied to a portable radio apparatus capable of supporting a plurality of frequency bands.

Description of Symbols

1, 2, 3, 4, 5, 6: portable radio apparatus

10: housing

10A: lower housing

10B: upper housing

11, 11A, 11B: circuit board

13, 13A, 61: feed part

14: antenna element (first antenna element)

15, 22, 40: ground wire

16: line switching switch

17, 18, 50: reactance element

20: plate-shaped inverted-F antenna

21: short point

30, 31: connector

32: flexible cable

41: metal conductor

60: second antenna e

1. A portable radio apparatus comprising:
a circuit board having a ground pattern;
a first feed part connected to a wireless circuit on the circuit board;
a first antenna element connected to the first feed part and arranged so as to face the ground pattern;
a passive element arranged between the ground pattern and the first antenna element; and
a line switching section that connects the ground pattern and one end of the passive element,
wherein the wireless circuit operates in two or more carrier frequency bands;
wherein the first antenna element is set with an electrical length resonating in at least one frequency band of the carrier frequency bands;
wherein the passive element is set with an electrical length resonating in a frequency band, which is different from the frequency band of the first antenna element, of the carrier frequency bands; and
wherein the line switching section electrically separates the ground pattern from the passive element in the frequency band with which the first antenna element resonates, and electrically connects the ground pattern to the passive element in the frequency band with which the passive element resonates.

2. The portable radio apparatus according to claim 1, further comprising:
a metal conductor connected to the ground pattern and provided to a ground pattern side.

3. The portable radio apparatus according to claim 2, wherein the passive element is configured as a circuit pattern formed on the circuit board.

4. A portable radio apparatus comprising:
a circuit board having a ground pattern;
a first feed part connected to a wireless circuit on the circuit board;
a first antenna element connected to the first feed part and arranged so as to face the ground pattern;
a passive element that arranged between the ground pattern and the first antenna element;
a line switching section that connects the ground pattern and one end of the passive element;
a first housing that includes the circuit board, the first feed part, the first antenna element, the passive element and the line switching section; and
a second housing slidably connected to the first housing,
wherein the wireless circuit operates in two or more carrier frequency bands;
wherein the first antenna element is set with an electrical length resonating in at least one frequency band of the carrier frequency bands;
wherein the passive element is set with an electrical length resonating in a frequency band, which is different from the frequency band of the first antenna element, of the carrier frequency bands; and
wherein the line switching section electrically separates the ground pattern from the passive element in the frequency band with which the first antenna element resonates, and electrically connects the ground pattern and the passive element in the frequency band with which the passive element resonates.

5. The portable radio apparatus according to claim 4, further comprising:
a metal conductor connected to the ground pattern and provided in the second housing.

6. The portable radio apparatus according to claim 5, wherein the passive element is configured as a circuit pattern formed on the circuit board.

7. The portable radio apparatus according to claim 1, further comprising:
a reactance element provided between the line switching section and the ground pattern.

8. The portable radio apparatus according to claim 1, further comprising:
a reactance element provided between the passive element and the line switching section.

9. The portable radio apparatus according to claim 1, further comprising:
a second feed part connected to the wireless circuit on the circuit board; and
a second antenna element connected to the second feed part,
wherein the second antenna element is set with an electrical length resonating in a frequency band, which is different from the frequency bands of the first antenna element and the passive element, of the carrier frequency bands.

10. The portable radio apparatus according to claim 4, further comprising:
a reactance element provided between the line switching section and the ground pattern.

11. The portable radio apparatus according to claim 4, further comprising:
a reactance element provided between the passive element and the line switching section.

12. The portable radio apparatus according to claim 4, further comprising:
a second feed part connected to the wireless circuit on the circuit board; and
a second antenna element connected to the second feed part,
wherein the second antenna element is set with an electrical length resonating in a frequency band, which is different from the frequency bands of the first antenna element and the passive element, of the carrier frequency bands.
